(19) United States
(12) Patent Application Publication
(10) Pub. No.: US 2025/0181209 A1
(43) Pub. Date: Jun. 5, 2025

(54) USER INTERFACE DEVICE, CONTROL DEVICE, AND NON-TRANSITORY COMPUTER-READABLE MEDIUM

(71) Applicant: KABUSHIKI KAISHA TOKAI RIKA DENKI SEISAKUSHO, Aichi (JP)

(72) Inventors: Komei SUGAWARA, Aichi (JP); Susumu MEGA, Aichi (JP); Yoshiaki NABE, Aichi (JP); Soki MORI, Aichi (JP); Satoru TAKENAWA, Aichi (JP)

(73) Assignee: KABUSHIKI KAISHA TOKAI RIKA DENKI SEISAKUSHO, Aichi (JP)

(21) Appl. No.: 18/836,964

(22) PCT Filed: May 12, 2023
(86) PCT No.: PCT/JP2023/017846

§ 371 Date: Aug. 8, 2024

(30) Foreign Application Priority Data
May 17, 2022 (JP) 2022-080883

(51) Int. Cl. G06F 3/04817; G06F 3/04845; G06F 3/04847

(52) U.S. Cl. CPC G06F 3/04817; G06F 3/04845; G06F 3/04847

(57) ABSTRACT

An arrow icon image associated with a controlled parameter and movable between a first position and a second position is displayed on a display device. Processing for changing the controlled parameter is initiated in response to reception of an instruction for displacing the arrow icon image. A shape of the arrow icon image is changed so as to have a portion indicating a movable direction on a path connecting the first position and the second position.

### FIELD

The presently disclosed subject matter relates to a user interface device. The presently disclosed subject matter also relates to a control device adapted to be installed in the user interface device, as well as a non-transitory computer-readable medium having stored a computer program adapted to be executed by a processor installed in the control device.

### BACKGROUND

Japanese Patent Publication No. 2013-022986A discloses a user interface device for controlling operations of a controlled device adapted to be installed in a vehicle as an example of a mobility. The device includes a display and a touchpad. Images such as icons or buttons indicating functions of the controlled device are displayed on a screen of the display. A user touches a detection area of the touch pad with his/her finger to input an operation, thereby performing selection of a certain image and execution of a function associated with the image.

### SUMMARY OF THE INVENTION

### Technical Problem

It is demanded to enhance the operability of such a user interface device as described above.

### Solution to Problem

An illustrative aspect of the presently disclosed subject matter provides a user interface device, comprising:
a display device; and
a control device configured to cause the display device to display an icon image that is associated with a controlled parameter and is movable between a first position and a second position, and to initiate processing for changing the controlled parameter in response to reception of an instruction for displacing the icon image,
wherein the control device is further configured to change a shape of the icon image so as to have a portion indicating a movable direction on a path connecting the first position and the second position.

An illustrative aspect of the presently disclosed subject matter provides a control device, comprising:
a processor configured to cause a display device to display an icon image that is associated with a controlled parameter and is movable between a first position and a second position; and
an interface adapted to receive an instruction for displacing the icon image,
wherein the processor is further configured to:
   initiate processing for changing the controlled parameter in response to reception of the instruction; and
   change a shape of the icon image so as to have a portion indicating a movable direction on a path connecting the first position and the second position.

An illustrative aspect of the presently disclosed subject matter provides a non-transitory computer-readable medium having stored a computer program adapted to be executed by a processor installed in a control device, the computer program being configured, when executed, to cause the control device to:
cause a display device to display an icon image that is associated with a controlled parameter and is movable between a first position and a second position;
initiate processing for changing the controlled parameter in response to reception of the instruction; and
change a shape of the icon image so as to have a portion indicating a movable direction on a path connecting the first position and the second position.

According to the configuration of each of the illustrative aspects, a user can intuitively understand the direction of the operation currently permitted with respect to the icon image for changing the controlled parameter. In addition, since the icon image, that is an item to be operated, exhibits such a direction by changing its own shape along with the displacement, it is possible to efficiently utilize the display area without unnecessarily increasing the amount of information provided to the user via the display device. Accordingly, it is possible to enhance the operability of the user interface device.

### BRIEF DESCRIPTION OF DRAWINGS

FIG. 1 illustrates an appearance of a vehicle in which a user interface device according to one exemplary embodiment is to be installed.

FIG. 2 illustrates a cabin of the vehicle of FIG. 1.

FIG. 3 illustrates a functional configuration of the user interface device of FIG. 2.

FIG. 4 illustrates one exemplary control screen to be displayed on a display device of FIG. 2.

FIG. 5 illustrates another exemplary control screen to be displayed on the display device of FIG. 2.

FIG. 6 illustrates another exemplary control screen to be displayed on the display device of FIG. 2.

FIG. 7 illustrates another exemplary control screen to be displayed on the display device of FIG. 2.

FIG. 8 illustrates another exemplary control screen to be displayed on the display device of FIG. 2.

FIG. 9 illustrates another exemplary control screen to be displayed on the display device of FIG. 2.

FIG. 10 illustrates another exemplary control screen to be displayed on the display device of FIG. 2.

FIG. 11 illustrates another exemplary control screen to be displayed on the display device of FIG. 2.

### DESCRIPTION OF EMBODIMENTS

Exemplary embodiments will be described in detail below with reference to the accompanying drawings. In each of the drawings referred in the following descriptions, the scale is appropriately changed in order to make each of the illustrated elements have a recognizable size.

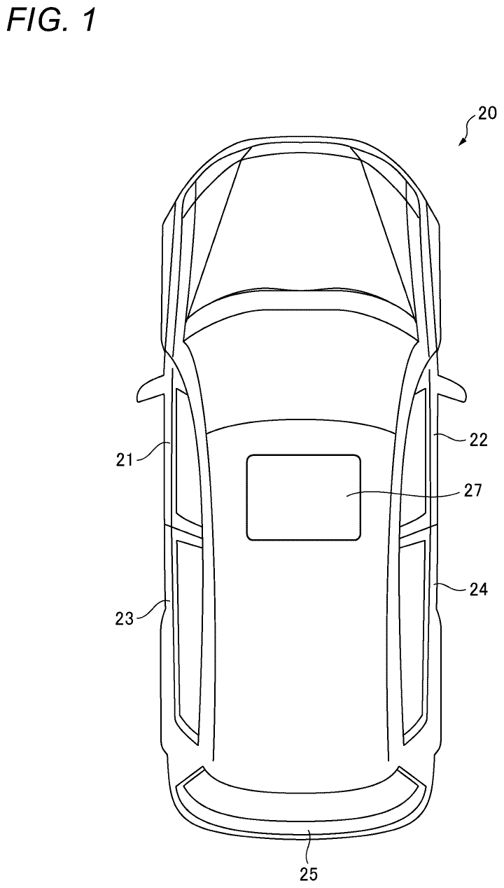

FIG. 1 illustrates a vehicle 20 in which a user interface device according to one exemplary embodiment is to be installed. The vehicle 20 includes a left front door 21, a right front door 22, a left rear door 23, a right rear door 24, and a rear door 25. Each of the left front door 21, the right front door 22, the left rear door 23, the right rear door 24, and the rear door 25 is an example of a movable body.

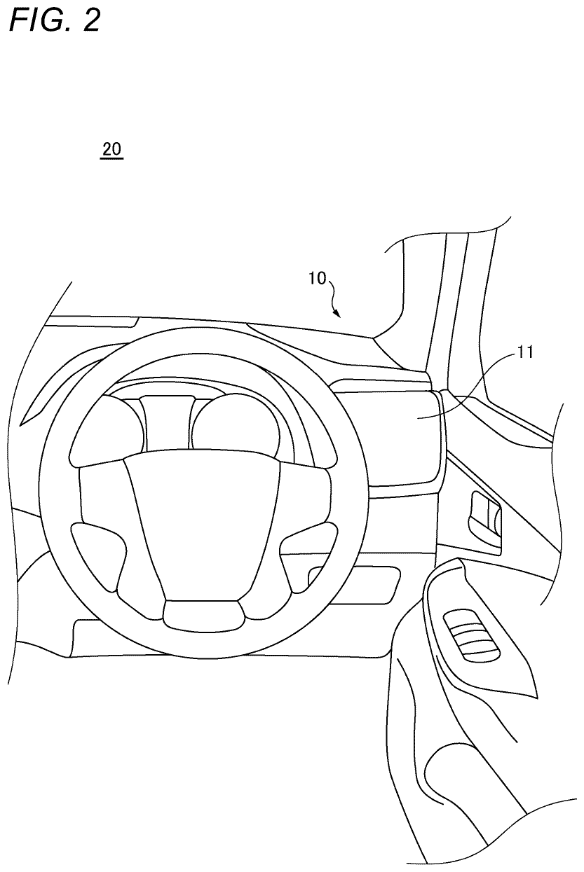

FIG. 2 illustrates a vehicle cabin of the vehicle 20. The user interface device 10 includes a display device 11. The user interface device 10 is configured to cause each of the left front door 21, the right front door 22, the left rear door 23, the right rear door 24, and the rear door 25 to automatically execute a locking/unlocking operation and an opening/closing operation through the use of the display device 11. In the following descriptions, the left front door 21, the right front door 22, the left rear door 23, the right rear door 24, and the rear door 25 will be collectively referred to as a “reclosable body” as required.

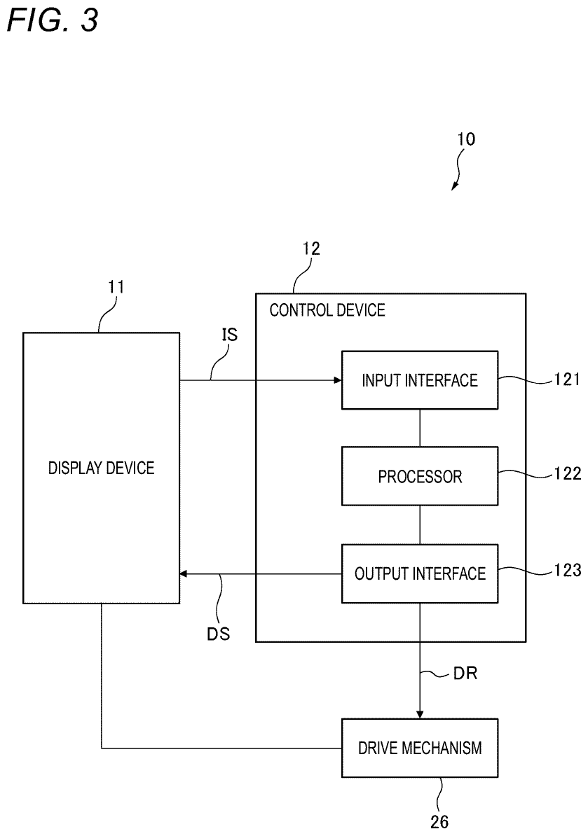

FIG. 3 illustrates a functional configuration of the user interface device 10. The user interface device 10 includes a control device 12. The control device 12 is configured to cause the display device 11 to display information for displacing the movable body, and configured to control the displacement of the movable body. The control device 12 is disposed at an appropriate position in the vehicle 20.

The control device 12 includes an input interface 121, a processor 122, and an output interface 123.

The input interface 121 is configured as a hardware interface adapted to receive an instruction signal IS for displacing the movable body. The instruction signal IS may be an analog signal or a digital signal. In the case where the instruction signal IS is an analog signal, the input interface 121 includes an appropriate conversion circuit including an A/D converter.

The processor 122 is configured to output, from an output interface 123, a drive control signal DR for causing a drive mechanism 26 installed in the vehicle 20 to realize the displacement of the movable body corresponding to the instruction signal IS. The output interface 123 is configured as a hardware interface. The drive control signal DR may be an analog signal or a digital signal. In the case where the drive control signal DR is an analog signal, the output interface 123 includes an appropriate conversion circuit including a D/A converter.

In this exemplary embodiment, the drive mechanism 26 constitutes a part of the locking/unlocking device and the opening/closing device provided for each reclosable body.

The processor 122 is configured to output, from the output interface 123, a display control signal DS for causing the display device 11 to display information for controlling the locking/unlocking operation and the opening/closing operation of each reclosable body. The display control signal DS may be an analog signal or a digital signal. In the case where the display control signal DS is an analog signal, the output interface 123 includes an appropriate conversion circuit including a D/A converter.

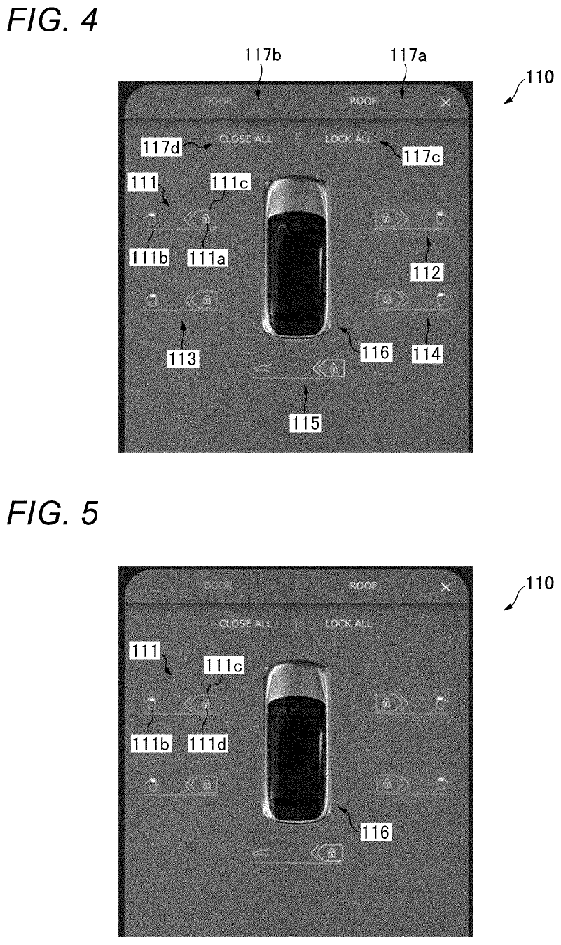

FIG. 4 illustrates a control screen 110 displayed on the display device 11 based on the display control signal DS. The control screen 110 includes a first control image 111, a second control image 112, a third control image 113, a fourth control image 114, a fifth control image 115, and a vehicle body image 116. The illustrated state corresponds to a state where all the reclosable bodies are closed and locked.

The first control image 111 is an image for controlling the locking/unlocking operation and the opening/closing operation of the left front door 21. The first control image 111 includes a locking icon image 111a, an opening icon image 111b, and an arrow icon image 111c.

The locking icon image 111a is arranged at a right end portion of the first control image 111. The right end portion is an example of a first position. The locking icon image 111a represents a state where the left front door 21 is locked.

The opening icon image 111b is arranged at a left end portion of the first control image 111. The left end portion is an example of a second position. The opening icon image 111b represents a state where the left front door 21 is opened.

The arrow icon image 111c is initially arranged at the right end portion of the first control image 111. A tip of the arrow is directed to the opening icon image 111b located on the left of the arrow icon image 111c.

The display device 11 has a touch panel function. The touch panel function may be realized by an electrostatic method or a pressure sensing method. The user of the vehicle 20 can unlock the left front door 21 by touching the locking icon image 111a displayed on the display device 11 with his/her finger.

Specifically, in response to detection of the position of the finger in the display device 11, an instruction signal IS indicating the position is inputted from the display device 11 to the input interface 121 of the control device 12. In a case where the position corresponds to the displayed position of the locking icon image 111a, the processor 122 outputs a drive control signal DR for causing the drive mechanism 26 to unlock the left front door 21 from the output interface 123.

In addition, the processor 122 outputs a display control signal DS for causing the right end portion of the first control image 111 to display an unlocking icon image 111d as illustrated in FIG. 5 from the output interface 123 to the display device 11. The unlocking icon image 111d represents a state where the left front door 21 is unlocked.

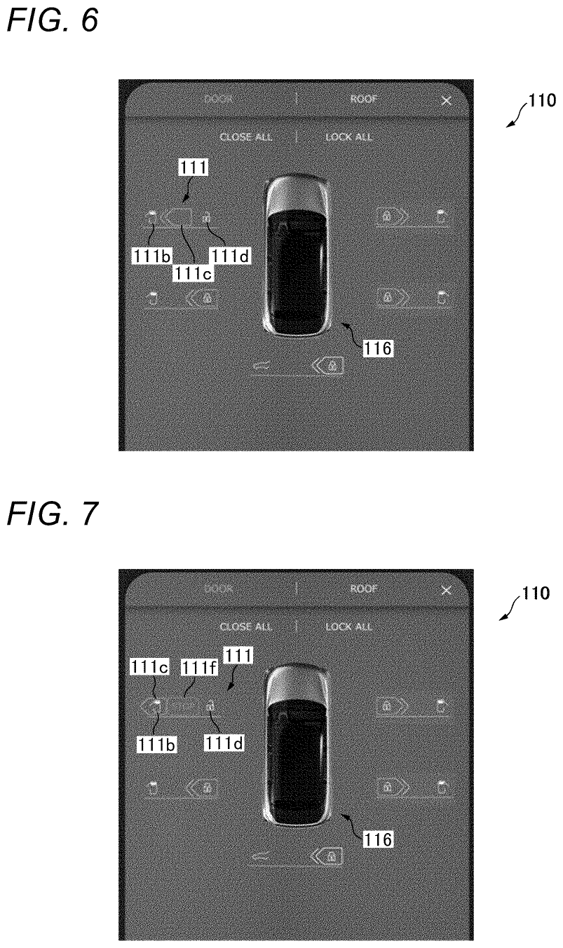

As illustrated in FIG. 6, the user can change the position of the arrow icon image 111c by a touch operation with his/her finger. A user who wishes to open the left front door 21 slides the arrow icon image 111c toward the opening icon image 111b.

In respect to detection of the slide operation with respect to the display device 11, an instruction signal IS indicating the position of the finger is inputted from the display device 11 to the input interface 121 of the control device 12. The processor 122 outputs a display control signal DS for changing the displayed position of the arrow icon image 111c so as to follow the position as detected, from the output interface 123 to the display device 11.

FIG. 7 illustrates a state where the arrow icon image 111c reaches the left end portion of the first control image 111. This state corresponds to a state where the instruction to open the left front door 21 is accepted.

Accordingly, the processor 122 outputs, from the output interface 123, a drive control signal DR for causing the drive mechanism 26 to open the left front door 21.

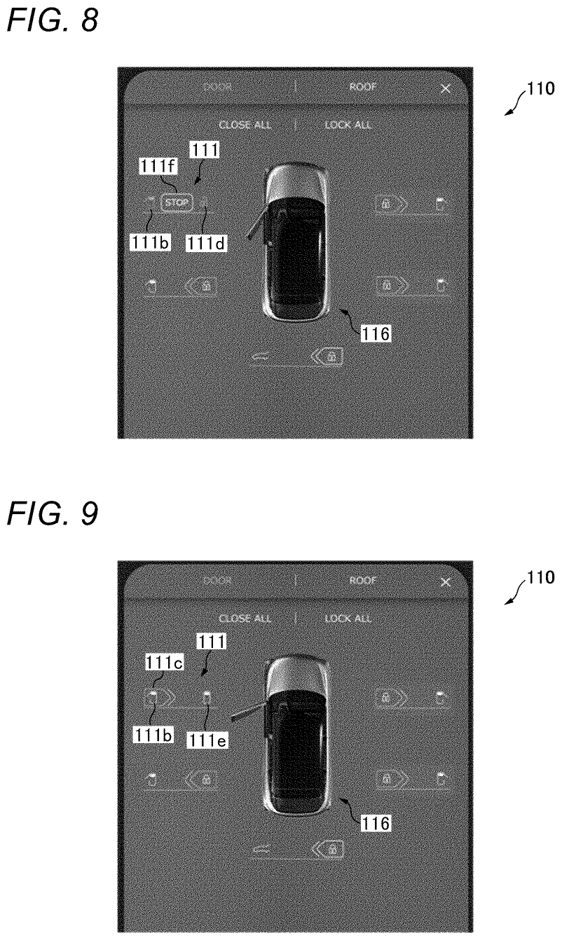

In addition, the processor 122 outputs, from the output interface 123, a display control signal DS for changing the vehicle body image 116 as illustrated in FIG. 8. Specifically, the vehicle body image 116 is changed so that an animation in which the left front door image opens is exhibited so as to correspond to the actual state of the left front door 21.

When the left front door 21 is fully opened, the vehicle body image 116 exhibits a state as illustrated in FIG. 9. At this time, the processor 122 outputs, from the output interface 123, a display control signal DS for displaying a closing icon image 111e at the right end portion of the first control image 111 in place of the unlocking icon image 111d. The closing icon image 111e represents a state where the left front door 21 is closed. In addition, the processor 122 outputs a display control signal DS for changing the direction of the arrow icon image 111c from the output interface 123. Specifically, the tip of the arrow is directed to the closing icon image 111e located on the right of the arrow icon image 111c.

A user who wishes to close the left front door 21 slides the arrow icon image 111c toward the closing icon image 111e. When the arrow icon image 111c reaches the right end portion of the first control image 111, the control screen 110 returns to the state illustrated in FIG. 5. The processor 122 outputs a drive control signal DR for causing the drive mechanism 26 to close the left front door 21 from the output interface 123. Although not illustrated, the vehicle body image 116 is changed so that an animation in which the left front door image closes is exhibited so as to correspond to the actual state of the left front door 21.

From the state illustrated in FIG. 5, the left front door 21 can be locked by touching the unlocking icon image 111d with his/her finger. Specifically, in response to detection of the position of the finger in the display device 11, an instruction signal IS indicating the position is inputted from the display device 11 to the input interface 121 of the control device 12. In a case where the position as detected corresponds to the displayed position of the unlocking icon image 111d, the processor 122 outputs, from the output interface 123, a drive control signal DR for causing the drive mechanism 26 to lock the left front door 21.

In addition, the processor 122 outputs a display control signal DS for causing the right end portion of the first control image 111 to display the locking icon image 111a as illustrated in FIG. 4, from the output interface 123 to the display device 11.

As has been mentioned above, in this exemplary embodiment, the arrow icon image 111c is configured to be movable between the right end portion and the left end portion of the first control image 111. The control device 12 is configured to initiate processing for changing the position of the left front door 21 between the closed position and the opened position, in response to reception of the instruction for displacing the arrow icon image 111c. The right end portion of the first control image 111 corresponds to the closed position of the left front door 21. The left end portion of the first control image 111 corresponds to the opened position of the left front door 21. The position of the left front door 21 is an example of a controlled parameter.

In addition, the control device 12 is configured to change the shape of the arrow icon image 111c so as to have a portion indicating a movable direction. As described above, when the arrow icon image 111c is displayed at the right end portion of the first control image 111, the direction of the tip of the arrow is changed so as to indicate the possibility of leftward displacement. Similarly, when the arrow icon image 111c is displayed at the left end portion of the first control image 111, the direction of the tip of the arrow is changed so as to indicate the possibility of rightward displacement.

According to such a configuration, the user can intuitively understand the direction of the operation currently permitted with respect to the arrow icon image 111c for opening or closing the left front door 21. In addition, since the arrow icon image 111c, that is an item to be operated, exhibits such a direction by changing its own shape along with the displacement, it is possible to efficiently utilize the display area without unnecessarily increasing the amount of information provided to the user via the display device 11. Accordingly, it is possible to enhance the operability of the user interface device 10.

As illustrated in FIGS. 4 and 5, in this exemplary embodiment, the locking icon image 111a and the unlocking icon image 111d as markers for receiving the instruction for locking/unlocking the left front door 21 are displayed within the arrow icon image 111c.

According to such a configuration, since it is possible to minimize the moving amount of the finger of the user when the locking/unlocking operation and the opening/closing operation of the left front door 21 are performed in succession, the operability of the user interface device 10 can be enhanced. However, the relationship between the displayed position of the locking icon image 1l1a or the unlocking icon image 111d and the displayed position of the arrow icon image 111c can be appropriately determined.

As illustrated in FIG. 8, the processor 122 of the control device 12 may be configured to output, from the output interface 123, a display control signal DS for displaying a stop icon image 111f while the processing for opening the left front door 21 is executed. The stop icon image 111f is displayed between the opening icon image 111b and the unlocking icon image 111d. In other words, the stop icon image 111f is displayed on the moving path of the arrow icon image 111c.

The stop icon image 111f is a marker for receiving an instruction to stop the processing for opening the left front door 21. In a case where the user wishes to interrupt the operation for opening the left front door 21 for some reason, a tough operation is performed with respect to the stop icon image 111f In a case where the position of the touch operation indicated by the instruction signal IS received by the input interface 121 corresponds to the displayed position of the stop icon image 111f, the processor 122 outputs a drive control signal DR for causing the drive mechanism 26 to stop the operation for opening the left front door 21 from the output interface 123.

The timing at which the stop icon image 111f is displayed may be at the same time as the arrow icon image 1l1c reaches the left end portion of the first control image 111 as illustrated in FIG. 7, or may be after the arrow icon image 111c disappears as illustrated in FIG. 8.

Although not illustrated, the processor 122 causes the stop icon image 111f to be displayed at the same position while the processing for closing the left front door 21 is executed. In this case, the stop icon image 111f is a marker for receiving an instruction to stop the processing for closing the left front door 21. In a case where the user wishes to interrupt the operation for closing the left front door 21 for some reason, a tough operation is performed with respect to the stop icon image 111f. In this case, the processor 122 outputs a drive control signal DR for causing the drive mechanism 26 to stop the operation for closing the left front door 21 from the output interface 123.

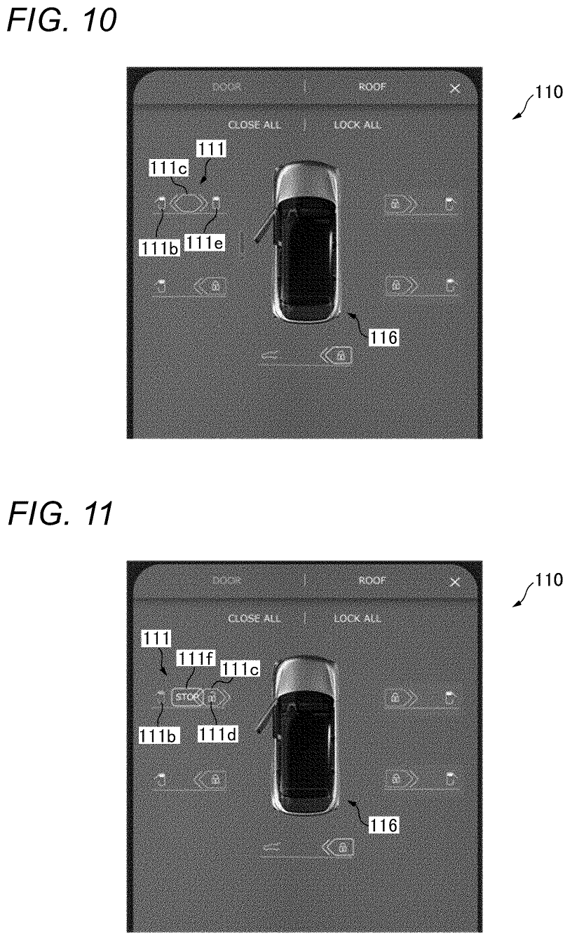

FIG. 10 illustrates a control screen 110 in a case where an operation is performed with respect to the stop icon image 111f. The processor 122 causes the display device 11 to display an arrow icon image 111c instead of the stop icon image 111f. In this case, the arrow icon image 111c exhibits a bidirectional arrow shape having a tip portion directed leftward and a tip portion directed rightward. In other words, the arrow icon image 111c indicates possibility of leftward displacement and rightward displacement.

In a case where the processing for opening the left front door 21 is interrupted, when the user moves the arrow icon image 111c leftward, the processing for opening the left front door 21 is restarted. Conversely, when the user moves the arrow icon image 111c rightward, the opening processing is stopped, and the left front door 21 is then closed. The user may select any of the options according to the situation.

FIG. 11 illustrates a case where the arrow icon image 111c is moved rightward from the state illustrated in FIG. 10. In a case where the arrow icon image 111c reaches the right end portion of the first control image 111, the closing icon image 111e is replaced with the unlocking icon image 111d, and the stop icon image 111f appears again on the moving path of the arrow icon image 111c. As a result, an instruction to stop the processing for closing the left front door 21 can be accepted. When the left front door 21 is fully closed, the control screen 110 returns to the state illustrated in FIG. 5.

In a case where the processing for closing the left front door 21 is interrupted, when the user moves the arrow icon image 111c rightward, the processing for closing the left front door 21 is restarted. Conversely, when the user moves the arrow icon image 111c leftward, the opening processing is stopped, and the left front door 21 is then opened. The user may select any of the options according to the situation.

The second control image 112 is an image for controlling the locking/unlocking operation and the opening/closing operation of the right front door 22. The arrangement and the displacement direction of each of various icon images included in the second control image 112 are symmetrical with respect to those included in the first control image 111. Since processes related to the display of the second control image 112 and the operation control of the drive mechanism 26 executed by the control device 12 are substantially the same as the processes related to the first control image 111, repetitive descriptions for those will be omitted.

The third control image 113 is an image for controlling the locking/unlocking operation and the opening/closing operation of the left rear door 23. The arrangement and the displacement direction of each of various icon images included in the second control image 112 are identical with those included in the first control image 111. Since processes related to the display of the third control image 113 and the operation control of the drive mechanism 26 executed by the control device 12 are substantially the same as the processes related to the first control image 111, repetitive descriptions for those will be omitted.

The fourth control image 114 is an image for controlling the locking/unlocking operation and the opening/closing operation of the right rear door 24. The arrangement and the displacement direction of each of various icon images included in the fourth control image 114 are symmetrical with respect to those included in the first control image 111. Since processes related to the display of the fourth control image 114 and the operation control of the drive mechanism 26 executed by the control device 12 are substantially the same as the processes related to the first control image 111, repetitive descriptions for those will be omitted.

The fifth control image 115 is an image for controlling the locking/unlocking operation and the opening/closing operation of the rear door 25. The arrangement and the displacement direction of each of various icon images included in the fifth control image 115 are identical with those included in the first control image 111. Since processes related to the display of the fifth control image 115 and the operation control of the drive mechanism 26 executed by the control device 12 are substantially the same as the processes related to the first control image 111, repetitive descriptions for those will be omitted.

The processor 122 of the control device 12 having various functions described above can be implemented by one or more exclusive integrated circuitries such as a microcontroller, an ASIC, and an FPGA equipped with a memory element in which one or more computer programs for implementing the functions are pre-installed. In this case, the memory element is an example of a non-transitory computer-readable medium having stored a computer program.

The control device 12 may be implemented by one or more non-exclusive microprocessors configured to cooperate with one or more non-exclusive memories. Examples of the non-exclusive microprocessor include a CPU, an MPU, and a GPU. Examples of the non-exclusive memory include a ROM and a RAM. In this case, one or more computer programs for implementing the functions may be stored in the ROM. The non-exclusive microprocessor designates at least a part of the program stored in the ROM, loads the program on the RAM, and executes the processing described above in cooperation with the RAM. In this case, the non-exclusive memory is an example of a non-transitory computer-readable medium having stored a computer program.

The processor 122 may be implemented by a combination of the non-exclusive microprocessor and the exclusive integrated circuitry.

Each configuration described above is merely illustrative for facilitating understanding of the presently disclosed subject matter. Each of the above exemplary configurations can be appropriately modified or combined with another exemplary configuration within the scope of the presently disclosed subject matter.

The user interface device 10 may be configured to control an opening/closing operation of another reclosable body installed in the vehicle 20. For example, as illustrated in FIG. 1, the vehicle 20 may include a sunroof 27. In this case, in response to a touch operation with respect to a roof selecting area 117a in the control screen 110 illustrated in FIG. 4, a GUI similar to the first control image 111 described above may be displayed. The GUIs described with reference to FIGS. 4 to 11 are displayed in response to a touch operation with respect to a door selecting area 117b in the control screen 110.

In a case where a touch operation is performed with respect to a full-lock selecting area 117c illustrated in FIG. 4, the processor 122 outputs, from the output interface 123, a drive control signal DR for causing the drive mechanism 26 to lock all reclosable bodies. Similarly, in a case where a touch operation is performed with respect to a full-close selecting area 117d illustrated in FIG. 4, the processor 122 outputs, from the output interface 123, a drive control signal DR for causing the drive mechanism 26 to close all reclosable bodies.

As another reclosable body adapted to be installed in the vehicle 20, a door window can be exemplified. In this case, the control screen 110 may include an area capable of accepting, for each door window, a touch operation for instructing provision of a GUI similar to the first control image 111.

The user interface device 10 may be configured to change a position of another movable body installed in the vehicle 20. Examples of another movable body may include a steering wheel, a seat, and a door mirror.

The user interface device 10 may be configured to change controlled parameters of various devices installed in the vehicle 20. Examples of such controlled parameters include temperature, an air volume, and an air direction of an air conditioner, brightness and a lighting direction of a lighting device, and the like.

The user interface device 10 may be installed in a mobility other than the vehicle 20. Examples of such a mobility include a railway, an aircraft, and a ship. Such a mobility may not require a driver.

The user interface device 10 need not be installed in a mobility. The user interface device 10 can be used to change the position of an appropriate movable body disposed in a house or facility. Examples of such a movable body include a door, a window, a shutter, a blind, a curtain, a screen, and the like. Alternatively, the user interface device 10 may be used to change an appropriate controlled parameter for which control is required in the house or facility.

The present application is based on Japanese Patent Application No. 2022-080883 filed on May 17, 2022, the entire contents of which are incorporated herein by reference.

1. A user interface device, comprising:
a display device; and
a control device configured to cause the display device to display an icon image that is associated with a controlled parameter and is movable between a first position and a second position, and to initiate processing for changing the controlled parameter in response to reception of an instruction for displacing the icon image,
wherein the control device is further configured to change a shape of the icon image so as to have a portion indicating a movable direction on a path connecting the first position and the second position.

2. The user interface device according to claim 1,
wherein the control device is configured to display a marker adapted to receive an instruction for interrupting the processing on the path while processing for changing the controlled parameter is executed.

3. The user interface device according to claim 1,
wherein the controlled parameter is a position of a reclosable body;
wherein the first position corresponds to a closed position of the reclosable body; and
wherein the second position corresponds to an opened position of the reclosable body.

4. The user interface device according to claim 3,
wherein the control device is configured to display, within the icon image, a marker adapted to receive an instruction for locking/unlocking the reclosable body at the first position.

5. A control device, comprising:
a processor configured to cause a display device to display an icon image that is associated with a controlled parameter and is movable between a first position and a second position; and
an interface adapted to receive an instruction for displacing the icon image,
wherein the processor is further configured to:
initiate processing for changing the controlled parameter in response to reception of the instruction; and
change a shape of the icon image so as to have a portion indicating a movable direction on a path connecting the first position and the second position.

6. A non-transitory computer-readable medium having stored a computer program adapted to be executed by a processor installed in a control device, the computer program being configured, when executed, to cause the control device to:
cause a display device to display an icon image that is associated with a controlled parameter and is movable between a first position and a second position;
initiate processing for changing the controlled parameter in response to reception of the instruction; and
change a shape of the icon image so as to have a portion indicating a movable direction on a path connecting the first position and the second position.
